(19) United States
(12) Patent Application Publication
(10) Pub. No.: US 2004/0182416 A1
(43) Pub. Date: Sep. 23, 2004

(54) Method and apparatus for removing minute particle(s) from a surface

(76) Inventors: Susan Davis Allen, Jonesboro, AR (US); Sergey I. Kudryashov, Jonesboro, AR (US)

Correspondence Address: FLESHNER & KIM, LLP, P.O. BOX 221200, CHANTILLY, VA, 20153, US

(21) Appl. No.: 10/626,880

(22) Filed: Jul. 25, 2003

Related U.S. Application Data
(60) Provisional application No. 60/398,100, filed on Jul. 25, 2002.

(51) Int. Cl. B08B 7/04; B08B 7/00

(52) U.S. Cl. 134/1.3; 134/1; 134/26; 134/18; 134/184; 134/902

(57) ABSTRACT

Methods and apparatus for removing minute particle(s) from a substrate. The methods include arranging an energy transfer medium having a predetermined thickness under and around one or more particle(s) to be removed, and irradiating the energy transfer medium and/or the surface of the substrate with pulsed energy, wherein the predetermined thickness of the energy transfer medium is selected so that viscous and other drag forces within the energy transfer medium are sufficient to cause the one or more particle(s) to be removed from the surface of the substrate. The apparatus include a tailored energy transfer medium application unit configured to control application of an energy transfer medium onto the surface of a substrate, and a tailored energy source that irradiates the energy transfer medium and/or the substrate with a tailored energy pulse or pulses, wherein the energy transfer medium application unit controls application of the energy transfer medium in accordance with a dimension of at least one of the particle(s).

### BACKGROUND OF THE INVENTION

1. Field of the Invention

The invention is directed to a method and apparatus for removing particles from a surface. More particularly, the invention is directed to a method and apparatus for removing minute particles from a surface using pulsed energy technology.

2. Background of the Related Art

Particle contamination of surfaces is a concern in many areas of technology. Two areas where such contamination can be a very significant problem are optics, particularly those with critical optical surfaces, and electronic device fabrication. The effect of contaminants on critical optical surfaces (coated or uncoated, dielectric or metal), for example in high power laser optics, can lead to increased optical absorption and a decreased laser damage threshold. Thus, as minute particles contaminate optical surfaces, they can serve as sinks for optical power incident on the optical surfaces and thus produce localized heating and possible damage. Large telescope mirrors, and space optics are other applications which require highly cleaned critical optical surfaces.

In the electronics industry, particle contamination is an important factor in the manufacture of high density integrated circuits. Even in relatively conventional technology using micron or larger circuit patterns, sub-micron size particle contamination can be a problem. Today the technology is progressing into sub-micron pattern sizes, and particle contamination is even more of a problem. For device fabrication, particles serve as “killer defects.” The term “device” includes electronic devices, including masks/reticles, optical devices, medical devices, and other devices where particle removal could be advantageous. Contaminant particles larger than roughly 10% of the pattern size can create damage, such as pinholes, which interfere with fabrication processes (such as etching, deposition and the like), and defects of that size are a sufficiently significant proportion of the overall pattern size to result in rejected devices and reduced yield. As an example, it has been found that the minimum particle size which must be removed in order to achieve adequate yield in a one Megabit chip (which has a pattern size of one micron) is about 0.1 microns. While a particle in a critical area on a wafer produces only one or at most, a few defective devices, adversely affecting device yield, a particle contaminated mask/reticle prints every device with a defect, reducing the yield to zero. At the shorter wavelengths being developed for the next generation of lithography, materials for a protective pellicle for the mask are not available, making particle removal techniques an essential technology in the future.

Filtration (of air and liquid), particle detection, and contaminant removal are known techniques used in contamination control technology in order to address the problems outlined above. For example, semiconductor fabrication is often conducted in clean rooms in which the air is highly filtered, the rooms are positively pressurized, and the personnel allowed into the room are decontaminated and specially garbed before entry is allowed. In spite of that, the manufactured devices can become contaminated, not only by contaminants carried in the air, but also by contaminants created by the processes used to fabricate the devices.

Removal techniques for contaminants should provide sufficient driving force for removal yet not destroy the substrate. Moreover, acceptable removal techniques should provide a minimum level of cleanliness in a reliable fashion. As the particle size decreases, the particle weight becomes less significant as compared to other adhesive forces binding the particle to the surface which it contaminates. Removal of such small particles, using conventional cleaning technologies such as high pressure air and liquid jets, can potentially damage the substrate.

In general, it has been found that sub-micron particles are the most difficult to remove. Many of the processes developed to clean integrated circuits, such as ultrasonic agitation, are not effective for micron and sub-micron particles and indeed, sometimes add contaminants to the substrate.

Laser assisted particle removal (LAPR) is a technique that has shown significant promise for removing minute, for example, both micrometer and nanometer scale, particles from critical surfaces, such as semiconductor wafers, high resolution photolithographic masks, high density magnetic recording media, large area high resolution optics and other critical surfaces. LAPR involves the rapid deposition of energy provided by lasers. Several different versions of LAPR exist depending on whether the laser energy is deposited in the particle, substrate or an energy transfer medium condensed under and around the particle.

The first Laser Assisted Particle Removal (LAPR) was probably observed in the early 1970s. Researchers who were studying the mechanisms of laser damage in materials for high power laser optics frequently observed and reported that a higher damage threshold was measured if one started at a low pulsed laser energy density and gradually increased the pulse energy until damage occurred (termed N/1, i.e., N shots on one site) as compared to the corresponding 1/1 experiments where each site was irradiated only once. The mechanism invoked for this damage threshold increase was surface cleaning during the initial low energy pulses. See, for example, S. D. Allen, J. O. Porteus, and W. N. Faith, Appl. Phys. Lett. 41, 416, 1982; S. D. Allen, J. O. Porteus, W. N. Faith, and J. B. Franck, Appl. Phys. Lett. 45, 997, 1984; and J. O. Porteus, J. B. Franck, S. C. Seitel, and S. D. Allen, Optical Engineering 25, 1171, 1986, which are hereby incorporated by reference. During these N/1 experiments, particulate removal could be detected via a decrease in scattering of the alignment beam (usually He—Ne) and by bright “meteor” trails observed as the removed particle(s) traversed the He—Ne beam.

It was not until the late 1980s, however, that such LAPR began to be studied on its own merits, spurred in large part by the problem of particulates on semiconductor wafer surfaces creating defects in lithographic patterns. This problem remains, as discussed above, and the scale has shrunk significantly since the early work—from approximately 1 μm to 10 nm or even less. Other critical surfaces which could benefit from an efficient LAPR system include: large area optics—both terrestrial and in space, masks for optical or x-ray lithography, electron or ion beam lithography, high-density magnetic recording media, and high power laser optics.

Initial LAPR experiments concentrated on mechanisms whereby the expansion of the laser heated particle or substrate under the particle provided momentum to the particle normal to the surface, respectively, producing a “hopping” effect where the particle is heated and a “trampoline” effect where the substrate is heated, resulting in its removal. Imen et al. introduced in 1990 the idea of an energy transfer medium (ETM) that absorbs the laser energy either directly, see K. Imen, S. J. Lee, and S. D. Allen, Appl. Phys. Lett. 58, 203, 1991, which is hereby incorporated by reference, or by conduction from the substrate as shown by Zapka et al., see W. Zapka, W. Ziemlich, and A. C. Tam, Appl. Phys. Lett. 58, 2217, 1991, which is hereby incorporated by reference. Many variations on these basic themes have subsequently been reported.

Laser assisted particle removal was described, for example, in U.S. Pat. No. 4,987,286 issued to Susan D. Allen on Jan. 22, 1991, which is hereby incorporated by reference. U.S. Pat. No. 4,987,286 discloses a method and apparatus for removing minute particles from a surface to which they are adhered using laser technology, and further teaches the use of an energy transfer medium to effect efficient laser assisted particle removal (LAPR). As shown in FIG. 1, a condensed liquid or solid energy transfer medium 23, such as water, is interposed under and around a contaminant particle 22 to be removed from a substrate 20 to which the particle is adhered. Thereafter, the medium 23 is irradiated using laser energy 25 at a wavelength which is strongly absorbed by the medium 23 causing explosive evaporation of the medium 23 with sufficient force to remove the particle 22 from the surface of the substrate.

Another particle removal technique has been to direct the laser energy into the substrate. The laser heated substrate then transfers energy into the energy transfer medium via conduction causing explosive evaporation sufficient to remove the particle from the surface of the substrate. Similarly, the laser energy can also be directed into the particle(s) to be removed.

Both direct absorption by the energy transfer medium, and substrate and/or particle(s) absorption with subsequent heating of the energy transfer medium can result in efficient LAPR and, as previously discussed, advances in technology have decreased the critical dimensions of various devices, such as, for example, magnetic hard drives, semiconductor devices, masks to make semiconductor devices, etc., and have also increased the surface quality requirements for devices such as large telescope mirrors, space optics, high power laser optics, etc. Therefore, the ability to remove particulate contamination in a noncontact clean fashion has become ever more important.

The above references are incorporated by reference herein where appropriate for appropriate teachings of additional or alternative details, features and/or technical background.

### SUMMARY OF THE INVENTION

An object of the invention is to solve at least the above problems and/or disadvantages and to provide at least the advantages described hereinafter.

The invention is directed to a method and apparatus for removing particles from a surface. More particularly, the invention is directed to a method and apparatus for removing minute particles from a surface using laser and other pulsed energy technology.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a diagram schematically illustrating a contaminated surface with adhered particles illustrating the practice of laser assisted particle removal;

FIG. 2A is a diagram schematically illustrating a surface bearing a contaminant particle prior to the introduction of an energy transfer medium thereon;

FIG. 2B is a diagram schematically illustrating the introduction of the laser onto the particle contaminated surface after the energy transfer medium is disposed on the surface;

FIG. 2C is a diagram schematically illustrating the removal of the contaminant particle from the surface;

FIG. 3 is a schematic diagram of a system for performing the methods according to the invention;

FIG. 3A is a schematic diagram of an alternative system for performing the methods according to the invention;

FIG. 4 is a schematic diagram of an alternative system for performing the methods according to the invention;

FIG. 5 is a flow chart illustrating a method according to the invention;

FIG. 6A is a graph illustrating optical reflectance recorded at various T_{dose} values according to embodiments of the invention;

FIG. 6B is a graph illustrating calculation of energy transfer medium thickness L for various T_{dose} values according to embodiments of the invention.

FIG. 7 is a graph illustrating cleaning thresholds F_{CL}(R, L) for various energy transfer medium thicknesses L according to embodiments of the invention; and

FIG. 8 is a graph illustrating a ratio of F_{INERT}/F_{DRAG} for various energy transfer medium thicknesses L according to embodiments of the invention.

### DETAILED DESCRIPTION OF PREFERRED EMBODIMENTS

The invention is directed to a method and apparatus for removing minute particles from the surface of a substrate using laser technology. Applicants have determined that above a “universal” cleaning threshold drag forces within an energy transfer medium are a dominant or significant removal mechanism acting to “drag” or pull particles from the surface of a substrate during explosive evaporation of the energy transfer medium from the substrate surface.

For example, when a thickness of a layer of energy transfer medium is of a sufficient dimension, drag and other forces in the energy transfer medium function to “drag” or pull the particle(s) off the surface of the substrate. In contrast to previously identified phenomena, in which the particles are bounced off the substrate (the “trampoline” effect caused by heating the substrate), hop off the substrate (the “hopping” effect caused by heating the particles themselves, which expand and “hop” off the substrate surface), or are pushed off the substrate (the “gas piston effect” where an energy transfer medium is heated and particles are pushed off the substrate by explosive evaporation of the energy transfer medium), by properly configuring the energy transfer medium, drag forces within the energy transfer medium can be utilized to “drag” or pull the particle(s) off the substrate during explosive evaporation of the energy transfer medium from the surface of the substrate.

The thickness of the energy transfer medium is significant. The thickness L of the energy transfer medium is selected so that viscous and other drag forces are sufficient to cause the one or more particle(s) to be removed from the surface of a substrate. In general, the thickness of the ETM layer should be large enough to maintain its liquid or solid form during liftoff from the substrate for a time sufficient to impart a velocity to the particle(s) sufficient to remove it from the surface and transport it a sufficient distance therefrom. The thickness should also be large enough to provide sufficient particle/ETM interaction, either via direct attraction or viscous drag, to remove the particle from the surface. The thickness L may be selected based on a dimension of the one or more particle(s), such as a radius R of the one or more particle(s). For example, if the thickness L of the energy transfer medium is set to be greater than or approximately equal to the radius R of the particles so that L≧R, the drag forces within the energy transfer medium function to “drag” or pull the particles off the substrate during removal of the energy transfer medium. Note that if there is sufficient attraction between the particle and the ETM, effective drag force particle removal may occur at L<R. Of course, this is only a positive effect up to a maximum thickness Lₘₐₓ of the energy transfer medium above which the energy required to remove the energy transfer medium from the substrate becomes so high as to be impractical, or removal of the energy transfer medium becomes impossible, taking into account the need to avoid damage to the substrate. Thus, the thickness L of the energy transfer medium is preferably within a range of R to Lₘₐₓ, more preferably R to 10R, most preferably R to 5R.

The viscosity of the energy transfer mechanism, chemical interaction between the particle(s) and the energy transfer mechanism, and adsorption energy may assist in removal of the particle(s) from the substrate surface. That is, any mechanism that contributes to the particle(s) maintaining contact with the energy transfer medium may assist in removal of the particle(s) from the substrate surface.

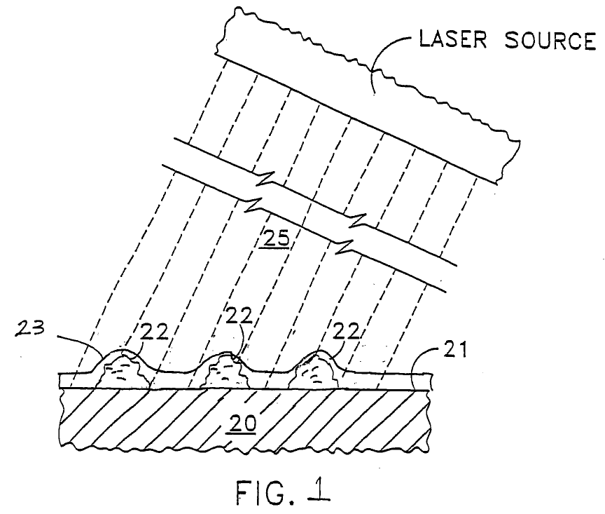

FIG. 1 shows, in cross-section, a portion of a substrate 20 bearing contaminant particles 22 which are adhered to a surface 21. The particle(s) 22 are bound to the surface 21 by any of a number of forces. The particle(s) are present usually as the result of a complex process which may include diffusion, sedimentation, inertia, and electrical or electrostatic attraction. When the particle(s) are very small, for example, micrometer and nanometer scale, gravity is a minor source of adhesion, and other sources of greater significance are Van der Waals forces, electrostatic forces, capillary forces, and the like. Adhesion forces and the factors necessary for dislodging particle(s) held by such forces will be considered in greater detail below. As the particle(s) become smaller, the forces causing adhesion tend to be significant as compared to the area of the surface affected and the volume or mass of the particle, and removal of such particle(s) becomes a rather significant problem.

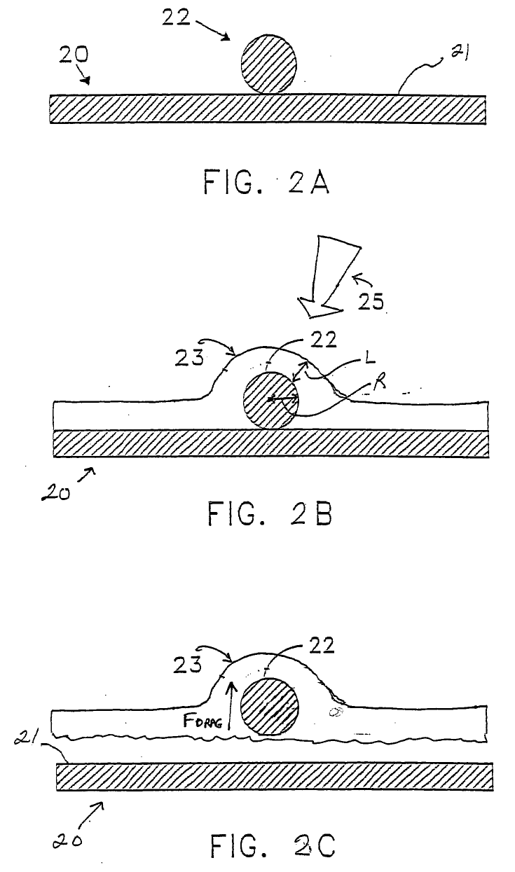

An energy transfer medium is deposited on the surface 21 in and around the particles 22, such medium being illustrated in the drawing as layer 23, which occupies interstices formed between the adhered particle(s) 22 and the surface 21. FIGS. 2A-2B illustrate the introduction of the energy transfer medium onto a surface bearing a contaminant particle.

After preparing the surface for cleaning, energy is impinged upon the surface to be cleaned, such energy preferably being at a wavelength which is absorbed by the substrate and/or energy transfer medium. In FIG. 1, pulsed energy 25 is directed at the surface 21 which carries the contaminant particle(s) and layer 24. The pulsed energy may include, for example, a laser beam, electron beam, ion beam, neutron beam, free electron laser (FEL) beam, etc., or a combination thereof. A quantity of energy is absorbed in the substrate and/or energy transfer medium, which is sufficient to cause explosive evaporation on the medium. When explosive evaporation occurs in a thin layer near the substrate surface, most of the energy transfer medium is lifted off the surface of the substrate, as shown in FIG. 2C. Using the system described below, if the thickness L of the energy transfer medium is of a sufficient dimension, drag forces F_{DRAG} function to pull the particle(s) from the surface 21 of the substrate.

Means may be provided for collecting, or otherwise removing dislodged particles once freed from the surface so as to prevent the particle(s) from redepositing on the surface. The explosive evaporation may occur with the substrate in a vacuum chamber, such that any dislodged particle(s) are removed by means of vacuum creating equipment. As an alternative, a gas jet can be provided which impinges a stream of gas onto the surface to carry the dislodged particle(s) away. In an application in the vacuum of space, no gas jet or additional vacuum system will be needed since the velocity imparted to the particle(s) will be adequate to transfer the particle(s) away from the surface. In any case, the requirement is simply to provide a velocity component to the particle(s) which will carry the particles away from the surface to avoid recontamination.

According to the methods and apparatus of the invention, the type of energy, the wavelength of the energy, the pulse length of the energy, the number of pulses and their timing, the energy density, the beam size and/or shape, the amount of the energy transfer medium and/or the composition of the energy transfer medium are precisely and selectively controlled. Some of the relevant considerations for tailoring the exact parameters for a specific application and environment, including consideration of the optical constraints of the materials and the size of the particles, are discussed in pending U.S. patent application Ser. No. 09/909,993 (Attorney Docket No. FSU-0003), entitled “Method and Apparatus for Removing Minute Particles from a Surface,” which is hereby incorporated by reference. The type and wavelength of the energy should be chosen to target the substrate, the ETM, or some combination thereof. The energy density should be above the removal threshold but below the damage threshold of the substrate or device of interest. Further, the energy density should be sufficient to be absorbed by the substrate, or the energy transfer medium, either directly or by conduction from the sample or substrate, or some combination thereof. The pulse length of the energy and spacing of the pulses is preferably sufficiently short in order to achieve the desired temperature distribution of the energy transfer medium, but not any shorter in order to decrease the likelihood of substrate damage. The beam shape and/or size is preferably as large as possible to clean as large an area as possible. Ideally, the beam is a uniformly intense beam. The irradiation geometry is chosen to optimize the energy transfer to the ETM and minimize substrate or device damage. The composition of the energy transfer medium may be selected such that it will interact with the particle to be removed and/or couple more efficiently to the laser being used. As will be discussed below, according to one embodiment of the invention, the thickness of the energy transfer medium may be selected to utilize the drag forces within the energy transfer medium to “drag” or pull the particle(s) from the surface of the substrate.

The energy transfer medium may be a liquid or a solid. The energy transfer medium may be an azeotrope, which is a constant boiling mixture, wherein the composition of the mixture does not change during evaporation. However, it is not necessary to use an azeotrope mixture to control the absorption of the energy transfer medium as separately controlled dual dosers can be utilized to achieve the same result. Strongly absorbing, condensable materials may be added to the energy transfer medium to enhance absorption of the energy into the substrate/energy transfer medium system.

The optimum absorption geometry for the most efficient laser assisted particle removal may consist of a combination of substrate and energy transfer medium absorption as a function of the particular particle(s)/substrate system.

Controlling the absorption of the energy transfer medium also allows irradiation from the back side of the substrate, a geometry of particular interest for masks and reticles. The laser energy can be directed through the substrate to an absorbing energy transfer medium.

Using a near UV (excimer) wavelength to effect LAPR on fused SiO₂ substrates, an ETM consisting of an azeotrope and water could be utilized. One example of an azeotrope involves a constant boiling mixture consisting of approximately 9% benzyl alcohol and approximately 91% water and boils at approximately 99.9° C. Benzyl alcohol absorbs strongly at approximately 248 and 193 nm. Again, since this mixture is azeotropic, it is convenient because the composition of the mixture does not change as it is evaporated. In contrast the 90% water/10% IPA (isopropyl alcohol) mixtures that are frequently used in excimer LAPR from Si surfaces are not azeotropic mixtures and concentration in the reservoir must be constantly monitored.

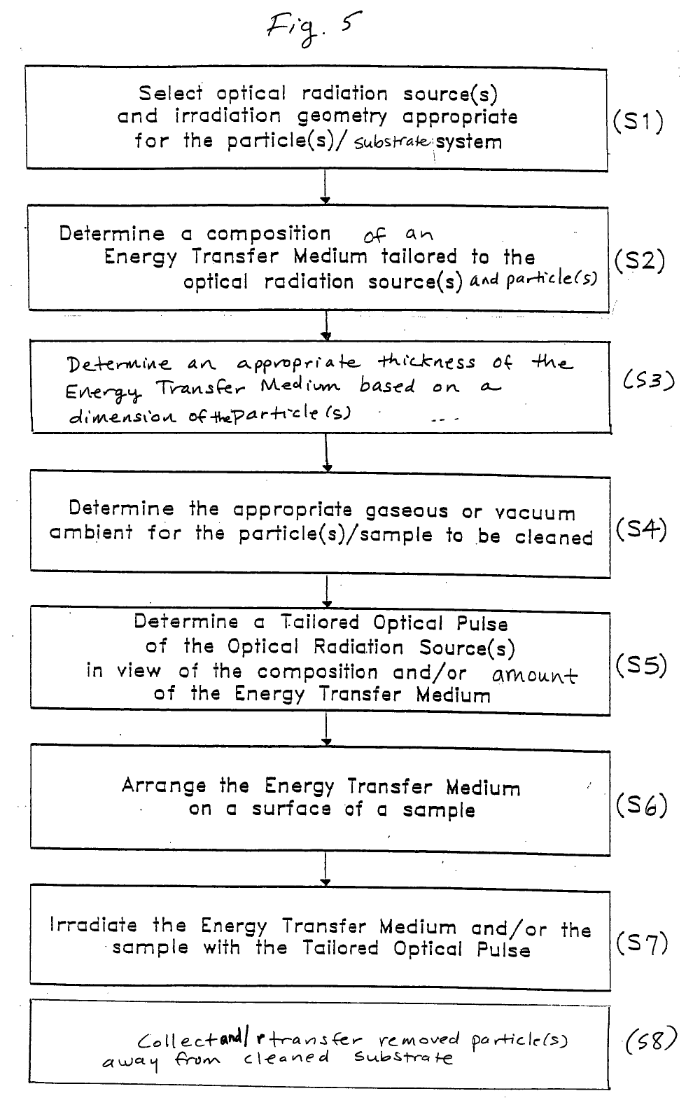

FIG. 5 illustrates a method according to the invention in the form of a flow chart. In step S1, an optical radiation source or sources and the irradiation geometry are selected. The optical radiation source(s) may be selected in accordance with a desired energy distribution, based on the particle(s)/substrate system. In step S2, the composition of an energy transfer medium is tailored to the optical radiation source(s), particle/ETM attractive forces, ETM viscosity, and ETM thermodynamic properties.

In step S3, an appropriate thickness of the energy transfer medium is determined. This thickness is that at which drag forces dominate removal of the particle(s). In general, the thickness of the ETM layer should be large enough to maintain its liquid or solid form during liftoff from the substrate for a time sufficient to impart a velocity to the particle(s) sufficient to remove it from the surface and transport it a sufficient distance therefrom. The thickness should also be large enough to provide sufficient particle/ETM interaction, either via direct attraction or viscous drag, to remove the particle(s) from the surface. According to one embodiment of the invention, this is determined based on a dimension of the particle(s) to be removed, such as the radius R of the particle(s) to be removed.

In step S4, the appropriate gaseous or vacuum ambient is determined for the particle(s)/sample/ETM system. In step S5, a tailored optical pulse of the optical radiation source is determined in view of the composition and/or amount of the energy transfer medium. Next, in step S6, the energy transfer medium is arranged on a surface of a sample. This can be accomplished by controlling a dosing time to provide a layer of energy transfer medium of a desired thickness. In step S7, either the energy transfer medium and/or the sample is irradiated with the tailored optical pulse. The incident energy caused explosive evaporation of the energy transfer medium from the substrate. At the same time, drag forces within the energy transfer medium “drag,” or pull contaminant particle(s) from the surface of the sample. In step S8, the removed particle(s) are collected and/or transferred away from the cleaned surface.

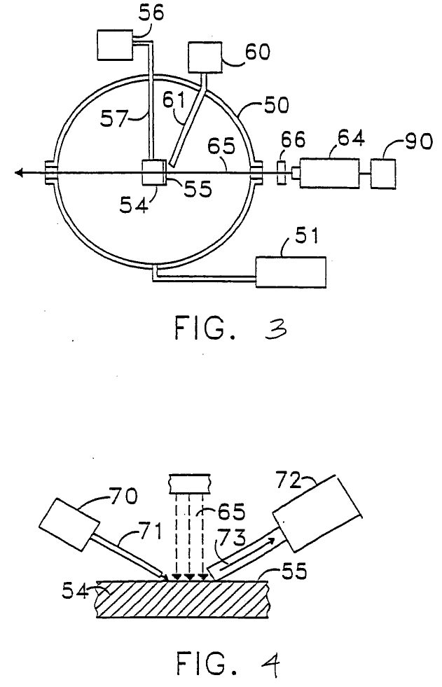

Turning now to FIG. 3, there is shown a system configured to practice the invention. The apparatus includes a sealable chamber 50 which is coupled to a vacuum source 51 for evacuating the chamber 50. Mounted on a support (not shown) in the chamber 50 is a substrate 54 to be cleaned. The substrate 54 has a surface 55 which contains contaminant particles (not shown in the scale of FIG. 3) to be removed.

For the purpose of controlling the adsorption and the description of liquid materials such as water, a cooling source 56 is coupled by conduit 57 to the substrate 54. As noted above, the temperature of the substrate 54 may be reduced to enhance ETM adsorption to the surface 55.

For the purpose of dosing the surface with an energy transfer medium, using, for example, a liquid such as water, alcohol, or a suitably chosen mixture, a liquid source 60 is provided and is coupled by a dosing tube 61 to the surface 55 of the substrate 54. Vapor supplied by source 60, is coupled through the dosing tube 61 and applied to the surface 55 at the appropriate temperature to ensure adsorption on the surface and in the interstices under and around the contaminant particles. After water dosing, the temperature of the substrate 54 can be maintained by the cooling source 56.

A source of pulsed energy 64 is provided with means 66 for steering the pulsed energy, if necessary. A pulse tailoring unit 90 is provided in communication with the source of pulsed energy 64. Input means (not shown) may be provided to allow a user to input the desired parameters to select a desired energy profile, or the parameters, including a thickness, of the energy transfer medium. In the former case, the user would input parameters that allow the pulse tailoring unit to control the output of the source of pulsed energy 64 to yield a tailored pulse having a desired energy distribution based on the application and/or environment. Alternately, the user could input the parameters of the desired optical pulse. In the later case, the user could input the parameters, including a thickness of the energy transfer medium, or the energy transfer medium dosing pulse, and the pulse tailoring unit 90 would tailor an optical pulse to produce an energy distribution suitable for the input energy transfer medium parameters.

After a sample is prepared for cleaning and the desired parameters are input into the pulse tailoring unit 90, the source of pulsed energy 64 is energized, and outputs pulses of energy as a beam 65 are directed to the surface 55. As an alternative, the sample itself can be moved within the chamber 50 to direct the energy beam to the desired area of the surface 55. In any event, the beam 65 is focused on the areas of the surface 55 which are to be cleaned and the laser 64 pulsed to couple adequate energy to the substrate/ETM/particle system.

As seen in FIG. 3, the sample 54 is mounted vertically such that particles (and ETM) which are driven from the surface 55 can fall by means of gravity without redepositing on the surface. The vacuum source 51 is filtered in order to remove particles (and ETM) which have been freed while maintaining the atmosphere within chamber 50 at a high vacuum and, therefore, clean. As an alternative, the samples 54 can be mounted horizontally with the surface 55 facing downward to get a further gravity assist for removal of particles once they are freed from the surface. Indeed, any mounting orientation could be adequate provided it is compatible with the mechanism for removing the dislodged particles. In most earthbound applications any orientation from the vertical illustrated in FIG. 3 to horizontally inverted will be acceptable in order to utilize a gravity assist in evacuating dislodged particles. When a system is utilized which introduces an external force for imparting particle velocity (such as the gas jet to be described below), other orientations for the surface to be cleaned might also be utilized. Alternatively, a cold plate (not shown) can be provided that draws the removed particles (and any ETM) away from the sample and prevents them from redepositing, or a temperature gradient can be utilized as taught in pending U.S. application Ser. No. 09/909,992 (Attorney Docket No. FSU-0004) entitled “Method and Apparatus for Laser Assisted Particle Removal Using Thermophoresis,” which is hereby incorporated by reference.

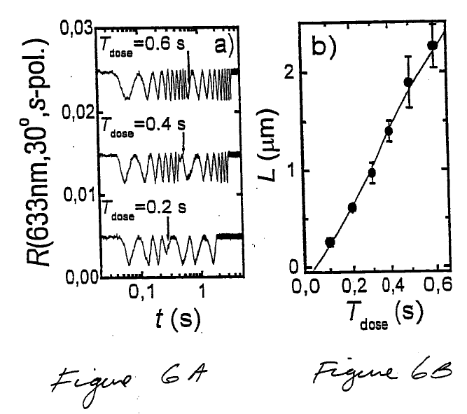

FIG. 3A shows another system configured to practice the invention. Provided along with a source 264 of pulsed laser energy and a pulse tailoring unit 290 is a tailored energy transfer medium application unit 500. The tailored energy transfer medium application unit 500 is designed to control application of an energy transfer medium onto the surface of a substrate, for example, in accordance with a dimension of one or more particle(s) to be removed from surface 255 of substrate 254. Accordingly to one embodiment of the invention, using the methodology of FIGS. 6A-6B, discussed below, the tailored energy transfer medium application unit may be designed to provide a desired energy transfer medium layer thickness, and hence enable the user to precisely produce the ETM thickness to remove a desired particle(s).

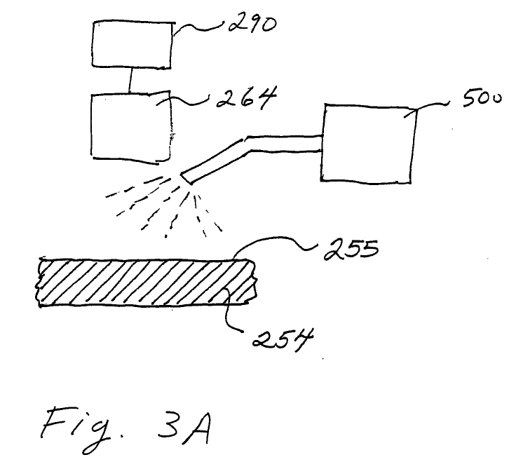

Turning now to FIG. 4, there is shown an alternative configuration adapted for removal of dislodged particle(s) before such dislodged particle(s) can redeposit on the surface. FIG. 4 does not contain all of the detail of FIG. 3 but instead shows only the substrate 54 having a contaminated surface 55 which is to be cleaned. The source of pulsed energy 65 is shown as being incident on the surface 55 which, as will be appreciated, has been dosed to provide an energy transfer medium under and around the particle(s) to be removed. Operating in conjunction with the source of pulsed energy 65 which dislodges the particle(s) is a gas source 70 and an outlet conduit 71 adapted to impinge a gas jet on the surface. A vacuum source 72 having a conduit 73 directed at the surface being cleaned can also be used for drawing away particle(s) freed by the source of pulsed energy 65. The system of FIG. 4 demonstrates that the invention can be practiced without a vacuum, but in most situations it will be useful to have an auxiliary mechanism, such as the gas jet, to impart a velocity to the dislodged particles to remove them from the area of the surface to avoid recontamination. This concept was disclosed in U.S. Pat. No. 5,024,968 issued to Audrey C. Engelsberg on Jun. 18, 1991, which is hereby incorporated by reference. It is noted above that in space-based applications, such a mechanism may not be necessary since the velocity imparted by drag forces within the energy transfer medium will impart adequate velocity to the particles to carry them away from the surface being cleaned, which is already in vacuum. In such an environment, ballistic transport to another critical surface can be prevented by appropriate placement of baffles. Thus, the system of FIG. 4 is merely exemplary of additional structure which can be used for removing particles once they are freed in the practice of the present invention.

The various system elements discussed above can be utilized in various combinations in order to configure a system tailored to a particular application and environment.

The invention will be discussed further below with respect to specific studies conducted by Applicants.

Steam laser cleaning (SLC), where a liquid Energy Transfer Medium (ETM) is utilized to effectuate contaminant or particle removal, has been demonstrated to be, according to one embodiment of the invention, a preferred approach for removal of particles, or contaminants from a surface of a substrate. SLC has been proven particularly effective at removing contaminants, such as sub-micron contaminants, from surfaces, such as lithographic masks, device substrates, high-power optic devices, and high-density memory devices. See, for example, K. Imen, J. Lee, and S. D. Allen, Appl. Phys. Lett. 58, 203, 1991; A. C. Tam, W. P. Leung, W. Zapka, and W. Ziemlich, J. Appl. Phys. 71, 3515, 1992; Y. F. Lu, Y. Zhang, Y. H. Wan, and W. D. Song, Appl. Surf. Sci. 138-139, 140, 1999; and M. Mosbacher, V. Dobler, J. Boneberg, and P. Leiderer, Appl. Phys. A: Mater. Sci. Process. 70, 669, 2000, which are hereby incorporated by reference. SLC may be used in various experimental geometries, e.g., depositing an energy absorbing transfer medium, such as an energy absorbing liquid layer, on a transparent substrate or a transparent energy transfer medium such as a transparent liquid layer on an energy absorbing substrate. See, for example, K. Imen, J. Lee, and S. D. Allen, Appl. Phys. Lett. 58, 203, 1991; Y. F. Lu, Y. Zhang, Y. H. Wan, and W. D. Song, Appl. Surf Sci. 138-139, 140, 1999; and M. Mosbacher, V. Dobler, J. Boneberg, and P. Leiderer, Appl. Phys. A: Mater. Sci. Process. 70, 669, 2000, which are hereby incorporated by reference. Model contaminating particles of different chemical types, such as, organic polystyrene (PS), oxides—alumina (Al₂O₃) and silica (SiO₂), carbides of boron and silicon, metallic (Mo, Au, Cu) particles, and particles with sizes from approximately nano- to micro-dimensions have been successfully cleaned from different substrates, such as Si, quartz, NiP and metallic surfaces, applying water or some organic liquids, such as 2-propanol (IPA), acetone, methanol, ethanol, as energy transfer medium (ETM) using SLC at various laser wavelength and pulse widths. See, for example, K. Imen, J. Lee, and S. D. Allen, Appl. Phys. Lett. 58, 203, 1991; A. C. Tam, W. P. Leung, W. Zapka, and W. Ziemlich, J. Appl. Phys. 71, 3515, 1992; Y. F. Lu, Y. Zhang, Y. H. Wan, and W. D. Song, Appl. Surf Sci. 138-139, 140, 1999; M. Mosbacher, V. Dobler, J. Boneberg, and P. Leiderer, Appl. Phys. A: Mater. Sci. Process. 70, 669, 2000; and X. Wu, E. Sacher, and M. Meunier, J. Appl. Phys. 87, 3618, 2000, which are hereby incorporated by reference. Importantly, a “universal” cleaning threshold has been reported for a broad approximately 60-800 nm range of PS particles for a nanosecond SLC with a water/IPA mixture as the ETM in the geometry “thin transparent liquid layer/absorbing Si substrate”. See, for example, M. Mosbacher, V. Dobler, J. Boneberg, and P. Leiderer, Appl. Phys. A: Mater. Sci. Process. 70, 669, 2000, which is hereby incorporated by reference.

Explosive boiling of a superheated liquid layer near the surface of a laser-heated solid absorbing substrate has been identified as the primary SLC mechanism from a series of experiments in “bulk” liquid layers in the mid-90s, when boiling threshold fluences, temperatures and pressures for various ETM and substrates were measured. See, for example, O. Yavas, P. Leiderer, H. K. Park, C. P. Grigoropoulos, C. C. Poon, W. P. Leung, N. Do, and A. C. Tam, Phys. Rev. Lett. 70, 1830, 1993; O. Yavas, P. Leiderer, H. K. Park, C. P. Grigoropoulos, C. C. Poon, W. P. Leung, N. Do, and A. C. Tam, Appl. Phys. A 58, 407, 1994; H. K. Park, C. P. Grigoropoulos, C. C. Poon, and A. C. Tam, Appl. Phys. Lett. 68, 596, 1996; H. K. Park, D. Kim, C. P. Grigoropoulos, and A. C. Tam, J. Appl. Phys. 80, 4072, 1996; and O. Yavas, A. Schilling, J. Bischof, J. Boneberg, and P. Leiderer, Appl. Phys. A 64, 331, 1997, which are hereby incorporated by reference. But, as has been shown recently, explosive boiling on a smooth surface, such as Si, has different quantitative parameters, i.e., considerably higher boiling temperature and boiling threshold, relative to that measured earlier for relatively rough metallic substrates, such as Cr or Au, corresponding, apparently, to the transition from heterogeneous boiling on rough metallic surfaces to homogeneous boiling on the smoother, commercially polished native oxide surfaces. See, for example, O. Yavas, P. Leiderer, H. K. Park, C. P. Grigoropoulos, C. C. Poon, W. P. Leung, N. Do, and A. C. Tam, Phys. Rev. Lett. 70, 1830, 1993; O. Yavas, P. Leiderer, H. K. Park, C. P. Grigoropoulos, C. C. Poon, W. P. Leung, N. Do, and A. C. Tam, Appl. Phys. A 58, 407, 1994; H. K. Park, C. P. Grigoropoulos, C. C. Poon, and A. C. Tam, Appl. Phys. Lett. 68, 596, 1996; H. K. Park, D. Kim, C. P. Grigoropoulos, and A. C. Tam, J. Appl. Phys. 80, 4072, 1996; O. Yavas, A. Schilling, J. Bischof, J. Boneberg, and P. Leiderer, Appl. Phys. A 64, 331, 1997, and M. Mosbacher, M. Bertsch, H.-J. Muentzer, V. Dobler, B.-U. Runge, D. Baeuerle, J. Boneberg, and P. Leiderer, Proc. SPIE, 2^{nd} International Symposium on Laser Precision Microfabrication, 16-18 May 2001, Singapore, which is hereby incorporated by reference. This near-critical (spinodal) nature of explosive boiling on smooth substrates, such as Si, has been demonstrated in recent photoacoustic experiments performed for approximately micron-thick liquid layers of water and IPA. A model of acoustic generation and lift-off of the entire ETM liquid layer, which assumes ultrafast simultaneous explosive boiling (spinodal decomposition) and expansion of a superheated ETM layer on a time scale of approximately 10⁻¹¹-10⁻¹⁰ s, providing a potential energy of elastic deformation to a cooler ETM overlayer followed by its rarefaction and lift-off, has been proposed, predicting fluence- and thickness-dependent lift-off velocities. See, for example, O, Yavas, A. Schilling, J. Bischof, J. Boneberg, and P. Leiderer, Appl. Phys. A 64, 331, 1997; F. F. Abraham, D. E. Schreiber, M. R. Mruzik, and G. M. Pound, Phys. Rev. Lett. 36, 361, 1976; Y. Dou, L. V. Zhigilei, N. Winograd, and B. J. Garrison, J. Phys. Chem. 105, 2748, 2001; and Y. Dou, L. V. Zhigilei, Z. Postawa, N. Winograd, and B. J. Garrison, Nucl. Intrum. Meth. Phys. Res. B 180, 105, 2001, which are hereby incorporated by reference. The predicted scaling relations for lift-off velocities have been confirmed in liquid plume optical transmission experiments, where lift-off velocities have been directly measured for water and IPA as a function of laser fluence and ETM thickness. See, for example, Appendix 1 entitled “Plume optical transmission studies of explosive boiling and lift-off of a thin 2-proponal layer in a laser heated Si substrate” by Applicants, which is hereby incorporated by reference. Moreover, the invention hypothesis of “viscous drag force” SLC origin has been put forward, based on the previous photoacoustic and plume transmission measurements, in addition to existing “gas piston” and “shock wave” models. See, for example, Y. F. Lu, Y. Zhang, Y. H. Wan, and W. D. Song, Appl. Surf Sci. 138-139, 140, 1999; and X. Wu, E. Sacher, and M. Meunier, J. Appl. Phys. 87, 3618, 2000, which are hereby incorporated by reference. Following from the “viscous drag force” hypothesis, it has been determined that the amount of ETM deposited is an important SLC parameter.

Thus, there has been a practical need to correspond ETM explosive boiling events and parameters with SLC nature within the known “gas piston”, “shock wave”, “viscous drag force,” or other possible mechanisms, which may allow construction of a general picture of SLC and optimization of cleaning conditions. See, for example, Y. F. Lu, Y. Zhang, Y. H. Wan, and W. D. Song, Appl. Surf Sci. 138-139, 140, 1999; and X. Wu, E. Sacher, and M. Meunier, J. Appl. Phys. 87, 3618, 2000, which are hereby incorporated by reference. One way Applicants have solved this problem is to find a correspondence of parameters of ETM explosive boiling with SLC thresholds studied as functions of ETM thickness and laser fluence for different chemical types of substrates, particles, and ETM. Applicants discuss below, as an example, SLC thresholds for different combinations of polar and non-polar sub-micron particles and ETM liquids, i.e., water and 2-propanol, deposited on a substrate such as Si, as approximately micron-thick layers of variable thickness measured in an experimental geometry “thin transparent liquid layer/absorbing Si substrate”. A SLC model of laser cleaning in this geometry has been proposed based on previous photoacoustic and liquid plume transmission measurements and has been confirmed by SLC results obtained. SLC perspectives in removal of nanocontaminants are discussed within the frame of the model.

The proposed models are supported by initial molecular dynamics (MD) simulations of laser assisted particle removal for a relatively simple two-dimensional Lennard-Jones fluid. See Appendix 2, entitled “Molecular laser-assisted particle removal using molecular dynamics” by K. M. Smith et al, and Appendix 4 entitled “Clustered Ensembly Averaging: A Technique for Visualizing Qualitative Features of Stochastic Simulation” by K. M. Smith et al., which are hereby incorporated by reference.

Examples of current models for effectuating removal of minute particles from a surface of a substrate are described below:

Dry laser cleaning (DLC) model: Laser heating of the substrate and/or particle(s), in the absence of an ETM, causing rapid expansion of the substrate and/or particle(s) and producing a “trampoline” effect if the substrate is rapidly heated or a “hopping” effect if the particle(s) is rapidly heated. Either mechanism or a combination of both can result in particle removal. However, air drag can slow down DLC and can also result in recontamination if the kinetic energy of the particle(s) is not greater than the air drag and other hindering forces. See Appendix 3 entitled “Ambient atmosphere effect on dry laser cleaning efficiencies for sub-micron particles” by Applicants, which is hereby incorporated by reference.

Shock wave model: For shock wave laser steam cleaning, the water film is transparent to the excimer laser and the laser energy is absorbed by the substrate. The authors of X. Wu, E. Sacher, and M. Meunier, J. Appl. Phys. 87, 3618 (2000), which is hereby incorporated by reference, propose that the rapidly heated substrate surface superheats the water layer adjacent to it, causing bubble nucleation. This is followed by the creation of a dense population of bubbles which coalesce in large numbers and, in this way, an insulating vapor layer at the water/substrate interface is generated; the phenomenon is called film boiling. See, for example, S. V. Stralen abd R. Cole, Boiling Phenomena, Hemisphere, Washington, 1979, vol.1), which is hereby incorporated by reference. A detailed description of the explosive evaporation of the water film is extremely difficult, due to the formation of a superheated liquid, the thermal instability of the bubbles and the development of nucleation centers. The incident laser energy density (10² mJ/cm²) is much larger than the heat energy density needed to heat liquid water to boiling (10⁻³ mJ/cm²) and to vaporization (10² mJ/cm²). See, for example, CRC Handbook of chemistry and physics edited by D. R. Lide and H. P. R. Frederikse, CRC Press New York, 1996, pp. 6-10 and 6-16), which is hereby incorporated by reference. The vapor layer isolates the heat continuously transferring from substrate to liquid water, so that the temperature distribution in the substrate is approximately the same as that during dry cleaning.

The generation of substantial pressure due to bubble collapse, which often causes undesirable cavitation damage on propeller blades, pumps, and hydraulic machines, has been known for many years, can also be used to remove particles from solid surfaces, such as during ultrasonic and megasonic cleaning. See, for example, D. H. Trevena, Cavitation and tension in liquids, Adam Higler, Bristol, 1987; and J. Bardina in Particles on surface 1: Detection, Adhesion and Removal, edited by Mittal K. L., Plenum, New York, 1988, p. 329, which are hereby incorporated by reference. During the ablation of a liquid film by a short-pulsed laser, the pressure production is ascribed to the explosive growth of bubbles by instantaneous heating. See, for example, H. K. Park, D. Kim, C. P. Grigoropoulos, and A. C. Tam, J. Appl. Phys. 80,4072, 1996; and O. Yavas, A. Schilling, J. Bischof, J. Boneberg, and P. Leiderer, Appl. Phys. A.: Matr. Sci. Process. 64, 331, 1997, which are hereby incorporated by reference. This bubble growth in the fluid medium generates an explosive blast wave whose shock front is perpendicular to the direction of the wave motion. The pressure jump of this shock is from atmospheric pressure Pₐₜₘ to the shock-generated pressure P_{shock}. The pressure increment P_{shock}−Pₐₜₘ is termed the overpressure Pₒᵥₑᵣ. When a blast wave impinges perpendicularly on an unyielding surface, the movement of the shock front is terminated abruptly, normal reflection occurs and the entire front is instantly subjected to a reflected overpressure P_{reflect} which is substantially greater than the overpressure Pₒᵥₑᵣ in the immediate surroundings.

During steam cleaning, the blast wave generated during the explosive growth of bubbles imposes a dynamic load on the particles in this field, which is characterized by a rapidly attained peak value, the reflected overpressure, followed by a decay which accompanies the decay in the blast wave, itself See, for example, G. F. Kinney, Explosive shocks in Air, Macmillan, New York, 1962, which is hereby incorporated by reference. The upper limit of the resulting removal force due to bubble generation is given by F_{bubble}=πrₚ ²P_{reflect}, where rₚ is the radius of the particle.

Energy transfer medium (ETM) models: Laser heating of the ETM and/or substrate causing explosive boiling of a thin layer of the ETM near the surface of the substrate. The thickness of the resulting gas phase layer depends on the laser energy density, the optical and thermal properties of the substrate and the ETM, and the laser pulse length. The rapid expansion (ΔV) of the heated gas under the particle(s) adhered to the substrate creates a “gas piston” effect, pushing the particle off of the substrate. For the common case of transparent ETM/absorbing substrate, the shorter the pulse for the same laser wavelength and energy, the thinner the gas phase layer resulting from the explosive evaporation. For this mechanism, the thinnest ETM layer that will produce sufficient energy to remove the particle(s) is sufficient. As shown below, the inertial or “gas piston” model predominates for ETM layers as thin as 10⁻⁴R, where R is the particle radius.

Here, a fourth approach, the “viscous drag” approach is presented. That is, Applicants propose according to methods and apparatus of the invention utilizing, when laser heating of the ETM or an absorbing substrate causes explosive evaporation of the ETM, viscous and attractive forces within the ETM which act to “drag” or pull the contaminant particle(s) off of a surface of the substrate.

As will be discussed in greater detail below, Applicants have determined for a particular particle/substrate/ETM system that when the ETM thickness, L, is of a sufficient dimension, drag and other forces within the energy transfer medium function to “drag” or pull the particle(s) off the surface of the substrate. For example, when the ETM thickness, L, is greater than or equal to the particle radius, R, such that L>R, the viscous drag forces of the ETM layer provide the predominant removal mechanism. In other words, the particle(s) stay embedded in the ETM layer during the initial stages of lift-off from the substrate and are then “dragged,” or pulled off of the surface of the substrate by the viscous drag forces within the ETM. As previously stated, the viscosity of the energy transfer medium, chemical interaction between the particle(s) and the energy transfer medium, adsorption energy, and any other mechanisms that contribute to the particle(s) maintaining contact with the energy transfer medium may also assist in the removal of the particle(s).

Experimental evidence discussed below shows that for energies below the explosive boiling threshold, an ETM layer having a thickness L greater than or equal to a radius R of particle(s) to be removed, such that L≧R. exerts sufficient drag force F_{DRAG} on particle(s) to raise the removal threshold above the DLC level. In other words, the energy FINERT imparted to the particle via the “trampoline” and “hopping” mechanisms is not sufficient to remove the particle if L≧R, unless energy greater than the DLC threshold energy φₜₕ^{DLC} is applied. This retarding effect is larger for smaller particles—those of greatest interest to the semiconductor fabrication industry. Additional laser energy is necessary to remove the particles up to the SLC threshold where explosive boiling occurs at the liquid/solid interface and the liquid layer is removed—along with the particle(s). The explosive boiling threshold thus provides a “universal” cleaning threshold for particle removal for ETM thickness greater than a characteristic value for each particle size.

Experimental Evidence

Applicants will first discuss experimental evidence that demonstrates the effect of a viscous drag force on quasi-dry laser cleaning thresholds for 0.1-0.55 μm radius polystyrene (PS) particles from Si substrates with predeposited micron-scale 2-propanol layers of variable thickness as discussed below.

Applicants utilized an ˜248-nm, ˜20-ns KrF excimer laser beam from a laser, for example, a Lambda Physik, LPX 210 excimer laser, apertured in its central part by a ˜1-cm wide vertical slit focused (f≈10 cm) at normal incidence onto a ˜0.25-mm thick Si(100) wafer (with a native oxide surface layer˜several nanometers thick) with a predeposited liquid 2-propanol (isopropyl alcohol, IPA) ETM layer. The Si wafer was mounted on a three-dimensional stage and irradiated using a single laser shot on each site. The laser beam had horizontal rectangular and vertical gaussian fluence, F, distributions, respectively, with the characteristic dimensions of x≈8 and σ_{y}≈1.3 mm. Laser energy [˜0.2 J/pulse (±˜3%) after the aperture] was attenuated by color filters, for example, color filters manufactured by Corning Glass Works, and was measured by splitting off a part of the beam to a pyroelectric detector, for example, a pyroelectric detector such as the Gentec ED-500 pyroelectric detector.

A dosing system was utilized, which included a source of pressurized nitrogen with a triggered valve, connected to a bubbler immersed in a glass flask filled with heated ETM and directed through a heated output nozzle to the Si surface placed at a distance of 5 cm from the nozzle. See, for example, S. J. Lee, K. Imen, and S. D. Allen, Appl. Phys. Lett. 61, 2314, 1992; and S. J. Lee, K. Imen, and S. D. Allen, Microelectron. Eng. 20, 145, 1993, which are hereby incorporated by reference. The dosing system utilized had a gas pressure of ˜0.7 bar, flask, liquid, and nozzle temperatures of ˜44° C., and a dosing pulse, T_{dose}, of ˜0.1-0.6 s was employed to deposit a homogeneous IPA layer of variable thickness L≈0.2-2.5 μm onto the Si wafer. To measure the thickness of the IPA layer at the instant of laser cleaning, the temporal interference fringes of optical reflectance, R(˜633 nm, ˜30°, s-pol.), of a HeNe laser beam focused on the center of the irradiated area at ˜30° angle of incidence were recorded during cleaning experiments at different T_{dose} values, as shown in FIG. 6A, and the corresponding ETM layer thickness L was calculated, as shown in FIG. 6B, using the well-known interference extrema rules. The heating excimer laser was fired ˜0.06 s after the end of each liquid deposition step accounting for a nearly ˜0.04 s delay for the dosing jet to propagate between the nozzle and the Si substrate surface. The gas valve and excimer laser were triggered manually in a single-shot mode with the corresponding delays using a pulse generator, for example, a Stanford Research Systems DG 535 pulse generator.

Single-shot laser cleaning with and without predeposited IPA layers was performed in ambient atmosphere for Si wafers covered with monodisperse PS particles of radii, R≈0.1, 0.25 and 0.55 μm, for example, Surf-Cal™ grade, density ρps of ˜1.05 g/cm³, relative standard deviation in R less than ˜1% from, for example, Duke Scientific Corp. particles were deposited on the Si wafer samples using an airbrush from a suspension of monodisperse PS particles in a water/ethanol mixture maintained at ˜55° C. Typical particle densities and average aggregation numbers for PS particles were about 10⁴-10⁵ cm⁻² and ˜3-4 particles/cluster, respectively. Analysis of laser-irradiated spots was made using dark-field optical microscopy, for example, dark-field optical microscopy manufactured by Mitutoyo W H, while cleaning thresholds F_{CL}(R,L) were taken under dry, quasi-dry and steam laser cleaning (DLC, QDLC and SLC) conditions by measuring the width of completely clean areas at their sharp boundaries. It should be noted that most of the ˜25% scatter in the F_{SLC}(R,L) data points can be attributed to optical interference at ˜248 nm in the thin transparent IPA layer on the Si substrate increasing or decreasing the absorbed laser energy.

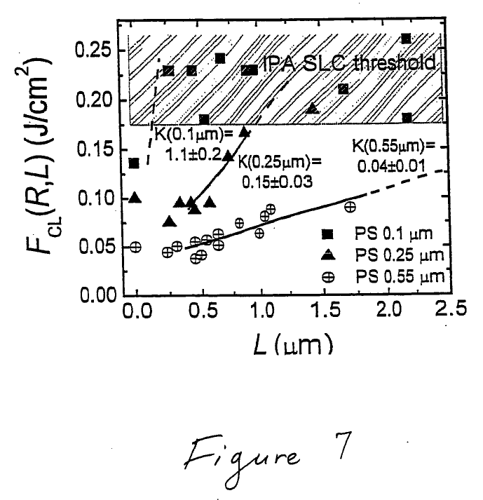

The resulting cleaning thresholds, F_{CL}(R,L), are shown in FIG. 7 as a function of particle radius and ETM film thickness. For film thickness 0≦L≦R, F_{CL}(R,L)≈F_{DLX}(R)≈0.05±0.01 and ≈0.10±0.01 J/cm² for ˜0.25 and ˜0.55-μm PS particles, respectively. Under these conditions, PS particles seem to be removed by DLC “trampoline” and “hopping” effects. At T≧R, F_{CL}(R,L) increases linearly with IPA film thickness, with slopes, K(R), increasing rapidly for decreasing particle size. For ˜0.1-μm particles the initial DLC-like region is not experimentally observed and F_{CL}(R,L) increases rapidly to a constant value of ˜0.22±0.04 J/cm². This IPA analog of the “universal SLC threshold” for ˜248-nm is shown as a band, F_{SLC}, in FIG. 7, which also includes one data point for ˜0.25-μm particles at L≈1.4 μm. See, for example, M. Mosbacher, V. Dobler, J. Boneberg, and P. Leiderer, Appl. Phys. A: Mater. Sci. Process. 70, 669, 2000, which is hereby incorporated by reference. The IPA explosive boiling and lift-off threshold, F_{B}≈0.17±0.02 J/cm², measured by plume optical transmission and contact photoacoustic techniques, is consistent with the average value of F_{SLC}. Thus, experimental results for ˜0.25 and ˜0.55-μm particles at F<F_{B} may be interpreted as quasi-dry laser cleaning (QDLC) from Si substrates damped by the IPA layer with SLC of ˜0.1, 0.25 and, most probably, 0.55-μm particles occurring at F>F_{B}.

To explain the role of the thin IPA layer below the SLC threshold, damping of PS particle initial lift-off velocities due to a viscous drag force in IPA has been considered. Assuming that, at the clean area boundary for each particle size, the initial lift-off velocities in air for different L should be equal to ΔV(F_{DLC}(R)) to prevent recontamination of the Si substrate, the Stokes viscous drag force effect for one-dimensional particle motion along a normal to the substrate surface is

$$\begin{matrix}Δ V ( {F}_{DLC} ( R ) ) = Δ V ( {F}_{QDLC} ( R , L ) ) exp ( \frac{- t ( L )}{{τ}_{IPA} ( R )} ) \\ = \frac{Δ V ( {F}_{QDLC} ( R , L ) ) {τ}_{IPA} ( R ) - ( L - R )}{{τ}_{IPA} ( R )}\end{matrix} \qquad ( 1 )$$

where the (L−R) term corresponds to the “effective” IPA layer thickness accounting for the PS particle center-of-mass position above the substrate surface, τ_{IPA}(R)=2 ρₚₛR²/9, η_{IPA} is the characteristic lift-off velocity relaxation time resulting from the viscous drag force and η_{IPA}(293 K)≈2.4×10⁻³ Pa.s is the IPA viscosity. See, for example, I. S. Grigor'ev, and E. Z. Meilikhov, Fizicheskie Velichini, Physical Quantities, Energoatomizdat, Moscow, 1991, (in Russian), which is hereby incorporated by reference. According to Eq. (1), the initial lift-off velocities ΔV(F_{QDLC}(R,L)) in the IPA environment should be higher than the initial velocity ΔV(F_{DLC}(R)) in air by the term (L−R)/τ_{IPA}(R) to account for deceleration due to the viscous drag force in IPA. The expression obtained by substituting τ_{IPA}(R) in Eq. (1), ΔV(F_{QDLC}(R,L))=ΔV(F_{DLC}(R))+(9η_{IPA}/2 ρₚₛR²)×(L−R), and the corresponding experimental fits F_{QDLC}(R,L)=F_{DLC}(R,L)+K(R)×(L−R) have the same functional form in agreement with theoretical predictions that particle velocity is linearly proportional to laser fluence for the “trampoline” and “hopping” cleaning mechanisms. See, for example, J. D. Kelley, M. I. Stuff, F. E. Hovis and G. J. Linford, SPIE Proc. 1415, 211, 1991; and N. Arnold, G. Schrems, T. Muehlberger, M. Bertsch, M. Mosbacher, P. Leiderer, and D. Boeurles, Proc. SPIE 4426, 340, 2003, which are hereby incorporated by reference. Indeed, the slopes of the F_{CL}(R,L) curves (K(˜0.55 μm)≈0.04±0.01 and K(˜0.25 μm)≈0.15±0.03) at L>R in FIG. 2 exhibit inverse quadratic dependence on R as predicted for ΔV(F_{QDLC}(R,L)). For ˜0.1-μm particles in the range of ˜0.1 μm≦L≦˜0.2 μm up to F_{SLC}, a slope K(˜0.1 μm)≈1.1±0.2 was predicted, calculated as an average of K(˜0.25 μm)×[(˜0.25 μm)/(˜0.1 μm)]² and K(˜0.55 μm)]×[(˜0.55 μm)/(˜0.1 μm)]², in agreement with the experimental data in FIG. 2.

Using the similar functional form of the predicted ΔV(F_{QDLC}(R,L)) and the experimental F_{QDLC}(R,L) results, a general scaling factor K_{D}=K(R)⁻¹×τ_{IPA}(R)⁻¹≈0.09 m³/J.s was found for ΔV(F_{QDLC}(R,L)) and initial lift-off velocities, ΔV(F_{DLC}(R))≈130, 90 and 45 m/s, were estimated at F≈F_{DLC}(R) and L≈R (no IPA effect) for particle radii of ˜0.1, 0.25 and 0.55 μm, respectively, assuming applicability of the “hopping” and “trampoline” mechanisms up to F_{SLC}. These values are considerably higher than those recently calculated for the same particles under dry conditions (about 80 and 15 m/s for 0.25 and 0.55 μm PS particles, respectively). One explanation of this overestimation of lift-off velocities is direct excimer laser heating of the PS particles, which absorb at the ˜248 nm laser wavelength, and the resulting strong temperature-dependent decrease of IPA viscosity in a boundary IPA layer surrounding the PS particles, e.g., τ_{IPA}(˜3531K)≈0.2×η_{IPA}(˜293K). See, for example, I. S. Grigor'ev, and E. Z. Meilikhov, Fizicheskie Velichini, Physical Quantities, Energoatomizdat, Moscow, 1991, (in Russian), which is hereby incorporated by reference. The velocities required to overcome IPA viscous drag, (L−R)/τ_{IPA}(R), calculated to be ˜100-150 m/s at F_{CL}(R,L) just below F_{SLC} for L_{SLC}(˜0.1 m)≈0.2 μm, L_{SLC}(˜0.25 μm)≈1.3 μm and L_{SLC}(˜0.55 μm)≈4.5 μm, in FIG. 7, ate similarly overestimated.

Thus, at laser fluences above the corresponding explosive boiling and lift-off threshold, the same viscous drag force in IPA or another liquid ETM may, conversely, enhance particle removal when the liquid ETM layer of a thickness of the same order of magnitude as the radius of the contaminant “drags off” these contaminants.

Accordingly, the effect of a viscous drag force on quasi-dry laser cleaning thresholds for sub-micron PS particles from Si substrates with predeposited micron-thick 2-propanol layers was demonstrated. Below the SLC threshold, viscous drag forces serve to impede particle removal and increase the removal threshold, while, above the SLC threshold, viscous drag forces contribute to steam laser cleaning as the liquid layer lifted off the surface by explosive boiling “drags” contaminants from the laser heated surfaces.

Next, Applicants provide a model of steam laser cleaning for round particles.

Applicants have extensively studied explosive boiling and lift-off of free transparent liquid films from nanosecond laser-heated surfaces of absorbing solid substrates for a wide variety of liquids and substrates because of its applications for steam laser cleaning of sub-micron and micron contaminants from critical surfaces. Heterogeneous boiling of bulk liquids on atomically rough metallic and amorphous Si substrates at interface temperatures far from corresponding critical temperatures of these liquids has been reported using optical reflectance, transmittance and surface plasmon resonance techniques. See, for example, O. Yavas, P. Leiderer, H. K. Park, C. P. Grigoropoulos, C. C. Poon, W. P. Leung, N. Do, and A. C. Tam, Phys. Rev. Lett. 70, 1830, 1993; O. Yavas, P. Leiderer, H. K. Park, C. P. Grigoropoulos, C. C. Poon, W. P. Leung, N. Do, and A. C. Tam, Appl. Phys. A 58, 407, 1994; H. K. Park, C. P. Grigoropoulos, C. C. Poon, and A. C. Tam, Appl. Phys. Lett. 68, 596, 1996; H. K. Park, D. Kim, C. P. Grigoropoulos, and A. C. Tam, J. Appl. Phys. 80, 4072, 1996; and O. Yavas, A. Schilling, J. Bischof, J. Boneberg, and P. Leiderer, Appl. Phys. A 64, 331, 1997, which are hereby incorporated by reference. Nonetheless, explosive boiling and lift-off of ˜micron-thick liquid films on atomically smooth Si substrates have been observed only at higher interface temperatures, 0.92T_{crit}≦T, occurring on a sub-nanosecond time scale, in near-interface liquid layers of thickness, L_{dep}˜(χτ*ₘᵢₙ)^{1/2}, of several nanometers, heated during a heating laser pulse by thermal conduction from the hot Si substrate in the liquid with the thermal diffusivity, χ, until explosive boiling onset. In this case boiling results, apparently, from homogeneous boiling/expansion (spinodal decomposition) of the unstable liquid layer on a time scale τ*ₘᵢₙ˜10⁻¹¹-10⁻¹⁰ s, providing compression of the top, cooler liquid overlayer dependent on its thickness, L_{c}, and mechanical rupture of a film/substrate contact due to formation of the vapor/droplet mixture. See, for example F. F. Abraham, D. E. Schreiber, M. R. Mruzik, and G. M. Pound, Phys. Rev. Lett. 36, 361, 1976; Y. Dou, L. V. Zhigilei, N. Winograd, and B. J. Garrison, J. Phys. Chem. 105, 2748, 2001; and Y. Dou, L. V. Zhigilei, Z. Postawa, N. Winograd, and B. J. Garrison, Nucl. Intrum. Meth. Phys. Res. B 180, 105, 2001, which are hereby incorporated by reference. Removal (lift-off) of the cooler overlayer occurs as its center-of-mass displacement during the rarefaction phase, while thickness-dependent lift-off velocities, V_{lift}, are described by

$${V}_{lift} \approx {C}_{l} \frac{V - {V}_{0}}{{V}_{0}} \frac{{L}_{dep}}{L} \qquad ( 2 )$$

where Cₗ and V₀ are the ETM sound velocity and molar volume under ambient conditions, V is the molar volume of the vapor/droplet mixture at the moment, τ_{RT}≈2L/Cₗ, of film detachment from the Si surface, accounting for that the total ETM layer thickness L=L_{dep}+L_{c}. Photoacoustic compressive response was estimated to approach to ˜10-10² MPa during spinodal decomposition of the near-interface unstable liquid layer increasing rapidly at near-critical and even supercritical interface temperatures. Lift-off velocities seem to have a maximum with increasing laser fluence as L_{dep} values decrease gradually with fluence above the corresponding lift-off threshold in contrast to temperature-dependent V values increasing at higher fluences.

To discuss SLC phenomenon, we will consider a stationary spherical particle on a flat solid substrate interacting due to an attractive adhesion force

F_{adh}(R)=R^{x} (3)

where the constant A accounts for the strength of this interaction (Hamaker constant) and its characteristic distance, z₀<˜1 nm. See, for example, X. Wu, E. Sacher, and M. Meunier, J. Appl. Phys. 87, 3618, 2000, which is hereby incorporated by reference. Elastic, plastic or none type of the interaction is accounted for both in this constant and the parameter, x, changing from ⅔ to 1 at transition from elastic to plastic or none particle deformation. We assume that lifting off liquid ETM film produces a steady-state flow around the particle which can be characterized by Reynolds number, Re=ρ_{L}1V_{lift}/η, qualitatively (apart from a factor of 2) representing a ratio of dynamic pressure, ρ_{L}V_{lift}²/2, to viscous stress, ηV_{ift}/L, where ρ_{L}, η are the mass density and viscosity of the ETM and L is a typical length in the flow problem under the study (in this case L˜R may be assumed). See, for example, R. G. Lerner and G. L. Trigg (Eds), Encyclopedia of Physics, VCH Publishers, New York, 1991, which is hereby incorporated by reference. At low Reynolds numbers, say Re˜1 or less, we can ignore the inertial momentum transfer to the liquid in comparison to the surface shear or fluid “friction” may be ignored. The cleaning drag force, F_{SCL}^{D} or F_{DRAG}, on the particle from the Stokes flow moving with a constant velocity, V_{lift}, is

F_{SLC}^{D}=6πηRV_{ift}. (4)

See, for example, R. G. Lerner, and G. L. Trigg (Eds), Encyclopedia of Physics, VCH Publishers, New York, 1991, which is hereby incorporated by reference. On the other hand, in a Reynolds number range around 10⁴, the inertial-type cleaning force, F_{SLC}¹, or F_{INERT} results from momentum transfer to the particle from the ETM layer underneath in the nearly inviscid flow

F_{SLC}¹=Bρ_{L}R²V_{lift}², (5)

where B is a constant somewhat less but on the order of magnitude of unity. For Re˜10⁵, the force determination is complicated by the transition from laminar viscous to turbulent flow near the spherical surface and to changes in the location of flow separation form the surface.

Substituting V_{lift} from Eq. (2) into the expression for Reynolds number, its dependence on R/L ratio can be determined as follows

$$Re ∼ {C}_{l} \frac{{ρ}_{L}}{η} \frac{V - {V}_{0}}{{V}_{0}} {L}_{dep} \frac{R}{L} , \qquad ( 6 )$$

which for the most, predominantly organic, liquids used in SLC is on the order Re˜R/L for ρ_{L}˜10³ kg/m³, η˜10⁻³ Pa-s and Cₗ˜10³ m/s, L_{dep}˜10⁻⁹ m,¹² and (V−V₀)/V₀≈1-2in the temperature range of 0.92 T_{crit}≦T≦T_{crit}. See, for example I. S. Grigor'ev, and E. Z. Meilikhov, Fizicheskie Velichini, Physical Quantities, Energoatomizdat, Moscow, 1991, Chaps. 5-15 (in Russian); and V. P. Skripov, E. N. Sinitsyn, P. A. Pavlov, G. V. Ermakov, G. N. Muratov, N. V. Bulanov, and V. G. Baidakov, Thermophysical Properties of Liquids in the Metastable State, Gordon and Breach, New York, 1988, which are hereby incorporated by reference. Thus, for R/L≦1 the viscous drag effect predominates above the explosive inertial acceleration of the particle, while the latter becomes important for R/L˜10⁴.

There are two necessary requirements to clean the particle of the substrate, which are:

1) F_{adh}(R)≦F_{SLC}^{D,I}; 2) E_{adh}(R)=A′×R^{x}≦M(R)ν² (7)

where E_{adh}(R) is the size-dependent particle/substrate adhesion energy with the interaction constant A′, M(R), v are the particle mass and velocity in a flow, respectively, in the substrate surface framework, where the latter reads for R/L≦1

$$\begin{matrix}v ( t ) = {v}_{0} + \frac{9 η}{2 {ρ}_{P} {R}^{2}} \frac{V - {V}_{0}}{{V}_{0}} \frac{{L}_{dep}}{L} {C}_{l} t \\ and R / L ∼ {10}^{4} & ( 8 ) \\ v ( t ) = {v}_{0} + \frac{3 B {ρ}_{L}}{4 π R} {( \frac{V - {V}_{0}}{{V}_{0}} )}^{2} {( \frac{{L}_{dep}}{L} )}^{2} {C}_{l}^{2} t & ( 9 )\end{matrix}$$

where ρₚ is the mass density of the particle and v₀ is the contribution to the particle velocity from the “trampoline” or “hopping” mechanisms well-known in dry laser cleaning. See, for example, A. C. Tam, W. P. Leung, W. Zapka, and W. Ziemlich, J. Appl. Phys. 71, 3515, 1992; and J. D. Kelley, M. I. Stuff, F. E. Hovis and G. L. Linford, SPIE Proc. 1415, 211, 1991; and N. Arnold, G. Schrems, T. Muehlberger, M. Bertsch, M. Mosbacher, P. Leiderer, and D. Baeuerle, Proc. SPIE 4426, 340, 2002, which are hereby incorporated by reference. It should be noted that for ˜micron-thick ETM films lift-off times, τ_{RT}, are much shorter than that of Si surface vibration cycles during thermal expansion of the near-surface laser-heated Si layer, being on the order of the heating laser pulse length. Thus, lift-off of the liquid film and the particle can be considered independently relative to the substrate surface vibrations.

Although we do not know exactly time duration of particle acceleration due to F_{SLC}^{D} or F_{SLC}^{I} forces, resulting in particle removal form the substrate, the two SLC requirements in Eq. (7) may be considered separately, accounting for the point-like, short-range character of the particle/substrate interaction, with the removal time, τᵣₑₘ˜z₀/U_{lift}, for the particle from the substrate is much shorter than the characteristic particle/ETM interaction time during acceleration of the particle, τ_{acc}˜R/V_{lift}. According to Eqs. (4) and [7(1)], the requirement for the particle removal for R/L≦1 is

$${Ar}^{x} \leq 6 π η {C}_{l} \frac{V - {V}_{0}}{{V}_{0}} \frac{{L}_{dep}}{L} R \qquad ( 10 )$$

which shows a L-dependent character of SLC threshold fluence due to a fluence dependence of V and L_{dep} values in this equation. The SLC threshold is R-independent for non-deformable or plastically-deformed particles with x=1, but the entire set of experimental parameters (F,L,η) should be optimized for elastically-deformed particles with x=⅔ exhibiting higher specific adhesion forces, AR^{x-1}, for smaller particles. For example, for plastically-deformed PS particles on the Si substrate with A≈0.1 J/m² calculated for the Hamaker constant, A^{PS—Si}≈1.2×10⁻¹⁹ J,²¹ and z₀^{PS—Si}≈0.4 nm,^{3,5} IPA as ETM (η≈(2-3)×10⁻³ Pa.s and Cₗ≈1.2×10³ M/s¹⁸), L_{dep}≈(1-3)×10⁻⁹ m,¹² and (V−V₀)/V₀≈1-2 in the temperature range of 0.92 T_{crit}≦T≦T_{crit},¹⁹ SLC may occur for L values increasing up to 4 microns. See, for example, Y. F. Lu, Y. Zhang, Y. H. Wan, and W. D. Song, Appl. Surf. Sci. 138-139, 140, 1999; X. Wu, E. Sacher, and M. Meunier, J. Appl. Phys. 87, 3618, 2000; I. S. Grigor'ev, and E. Z. Meilikhov, Fizicheskie Velichini, Physical Quantities, Energoatomizdat, Moscow, 1991, Chaps. 5-15 (in Russian); A. W. Adamson, Physical Chemistry of Surfaces, John Wiley, New York, 1990, ch. 6; and H. Krupp, Adv. Colloid Interface Sci. 1, 111, 1967, which are hereby incorporated by reference. Obviously, for non-deformed or plastically-deformed particles one can expect to see fluence-independent SLC for micrometer and much smaller sizes of these particles in a certain range of L values, corresponding to the well-known “universal SLC threshold.” See, for example, M. Mosbacher, V. Dobler, J. Boneberg, and P. Leiderer, Appl. Phys. A: Mater. Sci. Process. 70, 669, 2000, which is hereby incorporated by reference.

On the other hand, from Eqs. (5) and [7(1)] for R/L˜10⁴ we have

$${AR}^{x} \leq B {ρ}_{L} {{C}_{l}^{2} ( \frac{V - {V}_{0}}{{V}_{0}} )}^{2} {( \frac{{L}_{dep}}{L} )}^{2} {R}^{2} \qquad ( 11 )$$

where the SLC threshold fluence is L- and R-dependent. In the latter case, for plastically-deformed PS particles on the Si substrate with A≈0.1 J/m², IPA as ETM (ρ≈0.8×10³ kg/m³ and Cₗ≈1.2×10³ m/s), L_{dep}≈(1-3)×10⁻⁹ m and (V−V₀)/V₀≈1-2, L values should be less than (10⁻⁷×R)^{1/2} for SLC to occur for smaller particles.

The same approximate analysis can be done using Eqs. (8), (9) and [7(2)], assuming the particle acceleration time, τ_{acc}≈R/V_{lift}, and v₀≈0. Then, for R/L≦1 Eq.[7(2)] reads as

$${A}^{′} {R}^{x} \leq \frac{27 {πη}^{2}}{2 {ρ}_{P}} R \qquad ( 12 )$$

showing now L-, R—and even fluence-independent character of SLC, apparently, because of very rough approximation for τ_{acc}≈R/V_{lift}. Nonetheless, the requirement in Eq. (12) is fulfilled for typical parameters of IPA as ETM and PS particles for A′≈4×10⁻¹¹ J/m, being qualitatively consistent with Eq. (10). Furthermore, for R/L˜10⁴ we obtain

$${A}^{′} {R}^{x} \leq \frac{3 {B}^{2} {ρ}_{L}^{2} {C}_{l}^{2}}{8 {ρ}_{P}} {( \frac{V - {V}_{0}}{{V}_{0}} )}^{2} {( \frac{{L}_{dep}}{L} )}^{2} {R}^{3} \qquad ( 13 )$$

where the SLC threshold fluence is both L- and R-dependent in a qualitative agreement with Eq. (11). Evidently, in the latter case ETM type and, especially, its thickness should be optimized scaling in accordance with changes of particle size.

According to our estimates for micron and sub-micron particles, we can conclude that for ETM lift-off conditions corresponding to Stokes flow (Re˜1 or, in most cases, R/L˜1) SLC occurs due to the viscous drag force on contaminating particles. For non-deformable and plastically-deformed particles there are indications of the “universal” SLC threshold, appearing in the certain range of L>>L_{dep}. For elastically-deformed particles this “universal” threshold is absent and the entire set of experimental parameters (F,L,η) should be optimized for SLC of micron and sub-micron particles, e.g., adjusting (decreasing) the ETM thickness for removal of small particles. There is the evident upper limit for L of order of microns or tens of microns when SLC still occurs, while the upper limit for ETM lift-off may be somewhat higher, on the order of Cₗτ_{cool}˜10¹-10² μm, where τ_{cool} is the characteristic cooling time of the vapor/droplet mixture on the interface by thermal conduction. On the other hand, for smaller ETM thickness, L˜10⁻⁴R, ETM lift-off conditions correspond to the nearly inviscid flow (Re˜10⁴) and SLC proceeds due to inertial momentum transfer from explosively boiling and expanding ETM layer to the particles, while for different particle sizes ETM thickness should be scaled proportional to some power of R/L [see Eqs. (11) and (13)] for SLC to occur. Although for micron and sub-micron particles ETM thickness should be nanometer- or even subnanometer-thick (L≦L_{dep}) in the latter case due to the criterion for the ratio R/L˜10⁴, resulting in lift-off of a vapor/droplet mixture instead of the ETM liquid film, and fluid dynamics is no more applicable, this effect may have a minor contribution to dry laser cleaning of particles under ambient conditions, when negligible amounts of water and hydrocarbons can be adsorbed under the particles. See, for example, M. Mosbacher, H.-J. Muenzer, M. Bertsch, V. Dobler, N. Chaoui, J. Siegel, R. Oltra, D. Baeuerle, J. Boneberg, and P. Leiderer, in: Particles on Surfaces 7, edited by K. L. Mittal, VSP publishing, 2001, which is hereby incorporated by reference.

It is noted that the maximum thickness ETM that can be removed by explosive evaporation can be determined by momentum conservation, i.e., Ldep×Vexp=L×V0 where Ldep is the thickness of the heated layer and L is the total thickness of the layer. Vexp is the thermal expansion velocity of the explosively evaporated ETM layer and has a maximum near the spinodal decomposition curve of approximately Cl×DV/V0, where Cl is the longitudinal sound velocity, DV is the molar volume increase on vaporization and V0 is the molar volume of the ETM under ambient conditions.

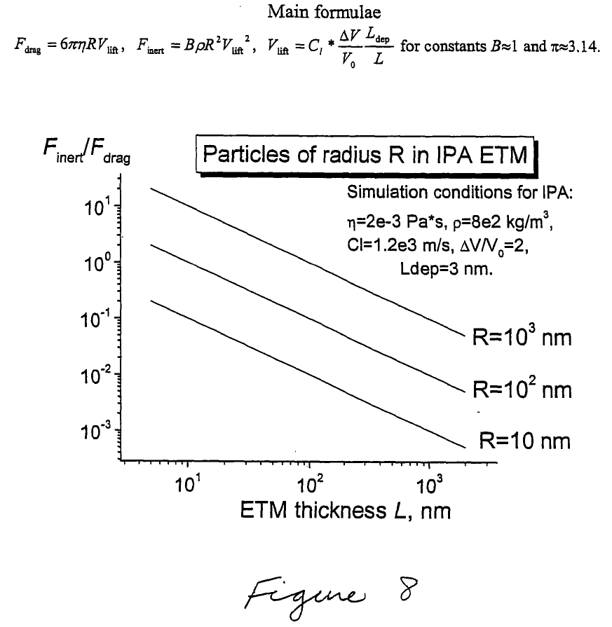

In FIG. 8, a ratio of F_{SLC}^{I}/F_{SLC}^{D} was plotted versus thickness L of the energy transfer medium for exemplary Reynolds numbers using the previously discussed model for round particles. The simulation conditions are noted in the graph. As can be seen in FIG. 8, for smaller Reynolds numbers the drag force is the predominant force in cleaning. For high Reynolds numbers inertial force is the dominant force in cleaning. FIG. 8 further illustrates that drag force becomes the predominant force in cleaning at or around L≧R for this system.

According to previous observations, a water layer of an average thickness of ˜0.4 μm deposited on a smooth Si surface consisted of separate droplets as the several nanometer-thick native silicon oxide surface film on a Si wafer surface is not wet by water and exhibits an expected contact angle of ˜20-45°. See, for example, W. H. Lawnik, U. D. Goepel, A. K. Klauk, and G. H. Findenegg, Langmuir 11, 3075, 1995, and references therein, which is hereby incorporated by reference. Deposition, laser removal and natural evaporation of the water droplet layer were monitored in a real time by observing the optical reflectance/scattering of a HeNe probe laser focused on the center of the irradiated area. Preliminary measurements of deposited water mass performed with a absorbent, CaSO₄ (Drierite), and drying times defined by the time to recovery of the initial HeNe reflectivity of the Si surface exhibit a linear increase in the amount of deposited H₂O with increasing dosing pulse length, T_{dose}, within the range of 0.1-1 s at a total deposition rate of 0.007 g/s. The real thickness of the water layer (the droplet's height), L, seems to remain nearly constant at about 1.5 μm over the wide range of T_{dose} values. The proportion of the Si surface covered with water droplets, S, increases linearly with increasing T_{dose}, rather than the droplet's size. Measuring the transversal distribution of water on the Si wafer from the corresponding measurements of drying times across the dosing area at different T_{dose}, an average thickness of the water layer of about 0.4 μm has been estimated for T_{dose}≈0.3 s using the known mass of water deposited and neglecting dosing transport losses. Although the real average radius of the water droplets (i.e., droplet's height, L^{L}) is a time-dependent value due to nucleation, Ostvald ripening and evaporation processes, an approximate value of about 1.5 μm can be obtained by dividing the average layer thickness by the surface coverage, S≈30%, which is a product of an average droplet area and the surface density of droplets calculated from optical photographs of the dosed Si surface.

The right half of each irradiated spot was treated with acetone to dissolve the PS particles, in order to test the Si substrate for surface damage underneath the particles. Digitized dark field images of scattered light from the irradiated spots were processed, including inversion and subtraction of background, using software, such as Scion Image software by Scion Corp., 1998. Spatial profiles of normalized scattering intensity (ratio of scattered light intensity taken vertically across laser-irradiated spots and an un-irradiated arbitrary area) were used to measure the degree of SLC for different irradiated regions.

Next, Applicants discuss the SLC results for PS and alumina particles on Si substrates, using isopropanol and water ETM.

PS particles—Most of the experimental work in DLC and SLC cleaning has been accomplished with PS particles because of their ready availability in a wide range of controlled particle sizes. For ˜0.5 μm particles, Mosbacher et al. have shown that the addition of a small amount of water under and around the particle can significantly lower the removal threshold. In order to obtain this result, it is necessary to perform the DLC measurements in high vacuum as ambient water vapor tends to adsorb in the capillary spaces created by the particle on the relatively smooth Si surface.

It is difficult to obtain data similar to that presented for PS/IPA, as discussed above, for the PS/H₂O system as H₂O does not wet the native oxide coated Si used as a substrate. Increasing the ETM dosing time does not significantly increase the droplet size formed on the surface, as discussed above, and removal thresholds as a function of ETM thickness is not, therefore, available.

Alumina particles—Some interesting preliminary results have been obtained for relatively large Al₂O₃ particles (˜1-10 μm) in H₂O and IPA. The DLC threshold for these irregular Al₂O₃ particles with a rather wide size distribution is about 0.24 J/cm². Using IPA, it was extremely difficult to remove the Al₂O₃ particles for any thickness of IPA. Normal dosing with H₂O lowered the removal threshold to <˜0.2 J/cm². It is possible that the interaction of water with the Al₂O₃ particles is greater than that of IPA. Such a ETM/Al₂O₃ interaction with water would increase the drag force on the Al₂O₃ particles relative to that for IPA.

The foregoing embodiments and advantages are merely exemplary and are not to be construed as limiting the invention. The present teaching can be readily applied to other types of apparatuses. The description of the invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A method of removing one or more particle(s) adhered to a surface of a substrate, comprising:
arranging an energy transfer medium having a predetermined thickness under and around one or more particle(s) to be removed; and
irradiating the energy transfer medium and/or the surface of the substrate with pulsed energy, wherein the predetermined thickness of the energy transfer medium is selected so that viscous and other drag forces within the energy transfer medium are sufficient to cause the one or more particle(s) to be removed from the surface of the substrate.

2. The method of claim 1, wherein the predetermined thickness of the energy transfer medium is greater than or equal to a radius of at least one of the one or more particle(s) to be removed.

3. The method of claim 1, wherein the one or more particle(s) comprise a plurality of particle(s) and the predetermined thickness of the energy transfer medium is greater than or equal to a radius of a largest of the particle(s) to be removed.

4. The method of claim 1, wherein the predetermined thickness of the energy transfer medium is greater than or equal to a radius of the one or more particle(s) to be removed and smaller than a maximum thickness at which insufficient pulsed energy is imparted to the energy transfer medium and/or surface of the substrate to remove the energy transfer medium from the substrate.

5 The method of claim 1, wherein the predetermined thickness of the energy transfer medium is selected so that the viscous and other drag forces in the energy transfer medium are sufficient to drag the one or more particle(s) from the surface of the substrate after the particle adhesion energy has been overcome by one of explosive evaporation of the energy transfer medium, particle expansion, and/or substrate expansion caused by the pulsed energy.

6. The method of claim 5, wherein the predetermined thickness of the energy transfer medium is selected so that the viscous and other drag forces in the energy transfer medium are sufficient to drag the one or more particle(s) from the surface of the substrate after the particle adhesion energy has been overcome by explosive evaporation of the energy transfer medium caused by the pulsed energy.

7. The method of claim 5, wherein the predetermined thickness of the energy transfer medium is selected so that the viscous and other drag forces in the energy transfer medium are sufficient to drag the one or more particle(s) from the surface of the substrate after the particle adhesion energy has been overcome by particle expansion caused by the pulsed energy.

8. The method of claim 5, wherein the predetermined thickness of the energy transfer medium is selected so that the viscous and other drag forces in the energy transfer medium are sufficient to drag the one or more particle(s) from the surface of the substrate after the particle adhesion energy has been overcome by substrate expansion caused by the pulsed energy.

9. The method of claim 1, wherein the energy transfer medium is transparent.

10. The method of claim 1, wherein the energy transfer medium is a liquid.

11. The method of claim 1, wherein the energy transfer medium is alcohol.

12. The method of claim 1, wherein the substrate is an absorbing substrate.

13. The method of claim 1, wherein an irradiation geometry is selected to maximize energy transferred to the energy transfer medium and minimize substrate damage.

14. A method of removing one or more particle(s) adhered to a surface of a substrate, comprising:
arranging an energy transfer medium having a predetermined thickness under and around one or more particle(s) to be removed; and
irradiating the energy transfer medium and/or the surface of the substrate with pulsed energy, wherein the predetermined thickness of the energy transfer medium is selected so that viscous and other drag forces within the energy transfer medium are sufficient to drag the one or more particle(s) from the surface of the substrate.

15. A method of removing one or more particle(s) adhered to a surface of a substrate, comprising:
interposing an energy transfer medium having a predetermined thickness about one or more particle(s) to be removed; and
absorbing a pulsed energy into the energy transfer medium and/or the surface of the substrate, wherein the predetermined thickness of the energy transfer medium is selected so that viscous and other drag forces within the energy transfer medium are sufficient to cause the one or more particle(s) to be removed from the surface of the substrate.

16. The method of claim 15, wherein the one or more particle(s) comprise a plurality of particle(s) and the predetermined thickness of the energy transfer medium is greater than or equal to a radius of a largest of the particle(s) to be removed.

17. A method of selectively removing particle(s) adhered to a surface of a substrate with an effective radius smaller than a predetermined value, the method comprising:
arranging an energy transfer medium having a predetermined thickness under and around one or more particle(s) to be removed; and
irradiating the energy transfer medium and/or the surface of the substrate with pulsed energy, wherein irradiating the energy transfer medium and/or the surface of the substrate with pulsed energy comprises irradiating the energy transfer medium and/or the surface of the substrate with pulsed energy to remove all particles(s) with an effective radius smaller than a predetermined value.

18. The method of claim 16, further comprising determining the radius of the smallest particles(s) to be removed.

19. The method of claim 16, wherein the predetermined thickness of the energy transfer medium is selected so that viscous and other drag forces within the energy transfer medium are sufficient to cause the one or more particle(s) to be removed from the surface of the substrate.

20. The method of claim 16, wherein the predetermined thickness of the energy transfer medium is greater than or equal to a radius of the smallest of the particle(s) to be removed.

21. Apparatus for removing one or more particle(s) from a surface of a substrate, comprising:
a tailored energy transfer medium application unit configured to control application of an energy transfer medium onto the surface of a substrate; and
a tailored energy source that irradiates the energy transfer medium and/or the substrate with a tailored energy pulse or pulses, wherein the energy transfer medium application unit controls application of the energy transfer medium in accordance with a dimension of at least one of the particle(s).

22. The apparatus of claim 21, wherein the energy transfer medium application unit controls application of the energy transfer medium in accordance with a dimension of at least one of the one or more particle(s).
